(19) United States
(12) Patent Application Publication
(10) Pub. No.: US 2019/0214892 A1
(43) Pub. Date: Jul. 11, 2019

(54) WAVE WINDING DEVICE AND METHOD FOR PRODUCING A WAVE WINDING

(71) Applicant: Aumann Espelkamp GmbH, Espelkamp (DE)

(72) Inventor: Wolfgang Lüttge, Hameln (DE)

(73) Assignee: Aumann Espelkamp GmbH, Espelkamp (DE)

(21) Appl. No.: 16/218,147

(22) Filed: Dec. 12, 2018

(30) Foreign Application Priority Data
Jan. 11, 2018 (EP) 18151157.7

(51) Int. Cl. H02K 15/04; H02K 15/00; B65G 15/42

(52) U.S. Cl. CPC H02K 15/0478; B65G 15/42; H02K 15/0006

(57) ABSTRACT

A wave winding device having a feed device and a winding device. The wave winding device has a wire entrainment device, which grasps a winding or a plurality of windings situated on the shaping core and entrains it or them in the transport direction. The wire entrainment device has a plurality of loose transport jaw members, each of which has a plurality of wire receiving grooves, a transport jaw placing device, which is situated in the area of the shaping core and places transport jaw members on the winding wire situated on the shaping core, and a transport jaw receiving device, which receives transport jaw members. The wire entrainment device further has a transport jaw entrainment device, which engages with the transport jaw members and moves these in transport direction.

### CROSS REFERENCE TO RELATED APPLICATIONS

This patent application claims priority on and the benefit of European Patent application No. 18151157.7 having a filing date of 11 Jan. 2018.

### BACKGROUND OF THE INVENTION

### Technical Field

The invention relates to a wave winding device, comprising a feed device, which provides at least one winding wire via at least one winding nozzle and transports it in a feed direction, a winding device, which winds the fed winding wire and comprises a shaping core, which is driven so as to rotate about a rotation axis, and which extends in a transport direction, a wire entrainment device, which is designed to grasp a winding or a plurality of windings situated on the shaping core and to entrain it or them in the transport direction, and to a method for producing a wave winding, in particular, by using a wave winding device as disclosed herein, wherein the method comprises feeding a winding wire to a winding device that includes a shaping core, winding the wire with the aid of the winding device by rotating the shaping core, and transporting the wire situated on the shaping core in a transport direction parallel to the rotation axis of the shaping core.

### Prior Art

A generic device or a generic method is known for example from EP 3 182 568 A1. In the method described therein, a plurality of winding wires is fed to the rotating shaping core of a winding device. The wire located on the shaping core is grasped by device of grippers and moved in a transport direction and the shaping core is rotated to produce the winding heads of the wave winding. In the process, a wave winding is produced on the shaping core, which is then transferred into a transport device. The transport device rotates in synchrony with the shaping core, so that the resulting wave winding may be continuously produced. With this device, it is possible to shape winding mats in any length with a relatively small shaping core.

The known device has, among other things, the disadvantage that grippers used there must be placed repeatedly on the wave winding, as a result of which damage to the winding wire becomes potentially more likely. Moreover, wave windings having equidistantly spaced windings are produced with the known grippers

Since these wave windings must be introduced in multiple layers, for example, into a laminated stator core once a winding mat is produced, this results in the disadvantage that winding mats having identical winding spacings are more difficult to introduce, since the actual required winding spacings change from winding layer to winding layer.

### BRIEF SUMMARY OF THE INVENTION

The object of the present invention, therefore, is to provide a wave winding device and a method for producing a wave winding, which avoid the disadvantages described.

For this purpose, the wave winding device according to the invention comprises the following:

A feed device, which provides at least one winding wire via at least one winding nozzle and transports it in a feed direction, a winding device, which winds the fed winding wire and comprises a shaping core which is rotatably driven about a rotation axis and which extends in a transport direction, and a wire entrainment device, which is designed to grasp one winding or a plurality of windings situated on the shaping core and to entrain it or them in the transport direction.

The wire entrainment device in this case comprises the following:

A plurality of loose transport jaw members, each of which has a plurality of wire receiving grooves, a transport jaw member placing device, which is situated in the area of the shaping core and is designed to place the transport jaw members on the winding wire situated on the shaping core, a transport jaw member receiving device, which is designed to receive transport jaw members, and a transport jaw entrainment device, which is designed to engage with the transport jaw members and to move these in the transport direction.

With the aid of the transport jaw members situated loosely in the device, it is possible to particularly gently produce a wave winding by placing the transport jaw members merely once on the winding and lifting them again after the wave winding is created. Thus, a frequent engagement and gripping is not required, so that the winding wire is handled particularly gently during the production of the wave winding and remains particularly protected from damage. Moreover, it is possible that of the plurality of transport jaw members, at least some transport jaw members comprise groove spacings that differ from other transport jaw members. With different groove spacings, it is possible to vary the winding spacings in the transport direction during the process of producing a wave winding.

To accelerate the production process, it may be provided, in particular, that the device according to the invention further comprises a transport jaw return device. This transport jaw return device is designed to return the transport jaws received by the transport jaw receiving device to the transport jaw placing device. In this way, a corresponding transport jaw member is immediately available again for further use as needed.

According to one preferred embodiment, it may be provided that the transport jaw members include linking sections, which are designed to link adjacent transport jaw members to one another. With this linkage, the further transport of all transport jaws can be greatly simplified, since in this respect, merely one device is required, which entrains one of the transport jaw members in the transport direction, so that as a result of the linkage all transport jaw members are moved in the transport direction.

According to another embodiment of the present invention, it may be provided, in particular, that the wire entrainment device includes a transport jaw guide, in which the transport jaw members may be guided in the transport direction. The guide configured in this way facilitates, in particular, also the entrainment of linked transport jaw members and reliably prevents a lateral slipping.

In order to be able to produce winding mats, the length of which is greater than the length of the shaping core, it is provided according to another embodiment of the present invention that the wire entrainment device may be rotated synchronously with the shaping core about an axis parallel to the transport direction. In theory, therefore, wave windings of any length may be produced and transported.

It may be advantageous that a pressing device advanceable in the direction of the wave winding and movable in the transport direction may be situated in the transport direction downstream from the transport jaw entrainment device. Thus, namely, the superposed windings of the wave winding may be pressed together to a minimum height, thereby giving the winding heads of the finished wave winding a preferably space-saving design.

According to another advantageous embodiment of the present invention, it may be provided that the transport jaw entrainment device is movable in the transport direction and is advanceable in the direction of the wave winding perpendicular to the transport direction. In this way, it is possible, in particular, in the case of linked transport jaws, for one transport jaw member each to be grasped by advancing the transport jaw entrainment device and to be displaced by moving the same in the transport direction. It may be provided that the transport jaw entrainment device is mounted on a carriage, which may be moved in the transport direction. The aforementioned pressing device may also be situated on the same carriage or on a separately guided carriage. The chain of transport jaw members is then conveyed by the device by repeated advancing and further transporting.

According to another preferred embodiment of the present invention, the wave winding device according to the invention comprises a stripping device, which facilitates the detachment of the transport jaw members from the wave winding. Detachment is necessary if the transport jaw member is to be removed again from the wave winding. Since it is possible that the winding wires lie deep within the grooves of the transport jaw members, a simple lifting of the transport jaw member from the wave winding may result, among other things, in the wave winding being raised locally at the relevant location where the winding tilts within the groove. This is avoided by the provision of a stripping device.

Alternatively, or in addition, it may be provided that a conveyor device is situated in the transport direction downstream from the wire entrainment device, which takes the wave winding from the wire entrainment device and transports it further. Such a conveyor device may then also be used, for example, to feed the winding mat resulting from the wave winding to a laminated stator core, so that the winding mat may then be connected with the laminated core in a continuous process.

For this purpose, it may be preferably provided that the conveyor device comprises a toothed belt, the teeth of which entrain the wave winding.

The invention further relates to a method for producing a wave winding, which may be carried out, in particular, by using a wave winding device as described above. According to the invention, the method comprises the following steps:

i) feeding a winding wire to a winding device that includes a shaping core;
ii) winding the wire with the aid of the winding device by rotating the shaping core;
iii) transporting the wire situated on the shaping core in a transport direction parallel to the rotation axis of the shaping core,
iv) placing at least one loose transport jaw member, which has a plurality of wire receiving grooves, on the shaping core wound with the wire, so that at least one winding of the wire is received in a wire receiving groove, and
v) moving the transport jaw member in the transport direction.

In this method, the steps iv) and v) are preferably carried out repeatedly.

The manufacture of wave windings is made significantly more flexible with the method according to the invention. On the one hand, the winding wire, in which transport jaw members are used, is handled with significantly greater care compared to known methods. On the other hand, there is also a wide range of possibilities for guiding the wire. Thus, for example, flat-lying flat wire, as well as flat wire guided upright, in addition to wire having a rounded cross section, may be held on the shaping core by the transport jaw members and processed to form wave windings. In addition, the transport jaw members—as mentioned above—also open the possibility of operating with guided wires having different parallel spacings, or to change the spacing between the wires during the process by using a set of transport jaw members, in which a plurality of transport jaw members have different groove spacings

Transport jaw members are preferably placed on both the upper side as well as on the underside of the resulting winding mats. According to one preferred method variant, this is done, in particular, by rotating the shaping core 180° between the steps iv) and v). In this way, merely one transport jaw placing device is required and each of the transport jaw members may be placed on the shaping core from above. This facilitates the process significantly.

According to one preferred refinement, it may be provided, in particular, that the movement step v) is carried out in such a way that the placed transport jaw member is moved by approximately half the length of the placed transport jaw members in the transport direction before the shaping core is rotated by 180°. As a result of this measure, chains of transport jaw members are produced on both flat sides of the wave winding, which are situated offset to one another by half the length of the transport jaw members.

One variant, in particular, is advantageous, in which a new transport jaw member, when being placed, is linked in each case with the immediately preceding transport jaw member in the transport direction. For this purpose, the transport jaw members may include corresponding linking sections on the front ends thereof situated in the transport direction. These are preferably designed, for example, on the tongue and groove principle, so that when setting a transport jaw member on the shaping core, a corresponding linking section of the placed transport jaw member is connected to a matching linking section of the respectively preceding transport jaw member.

In order to ensure a quieter and better guidance of the resulting winding mat and, in particular, to also simplify the later takeover of a resulting map by a conveyor device, it may be provided, in particular, that in step v) two transport jaw members are placed on the shaping core spaced parallel apart from one another. In this way, the toothed belt of a conveyor device, for example, may later grasp and further convey sections of the wave winding situated between the transport jaw members, while the transport jaw members are still situated on the wave winding.

To carry out the step iv), it may be provided according to one preferred embodiment of the present invention that a transport jaw entrainment device movable in the transport direction is initially advanced to a transport jaw member, then engaged with the transport jaw member, subsequently fed forward and, after being fed forward, detached again from engagement with the transport jaw member. Repeating this process results in a continuous conveyance of the linked transport jaw members and, therefore, in a continuous conveyance of the wave winding produced by the wave winding device used.

According to another preferred embodiment, it is provided in the process that the wave winding is pressed together with the aid of a pressing device that is movable in synchrony with the forward feed movement of the transport jaw members in the transport direction. As a result, the space later occupied by the winding heads in the wave winding may be designed as minimal as possible.

Given the fact that corresponding wave windings must generally be laid in multiple layers about the poles in laminated cores, it may be advantageous if the winding mat, when introducing it into such a laminated stator core, may be introduced as tension-free as possible. Since the diameter of the corresponding winding layer changes with each winding layer, the tension in the entire winding mat increases from mat to mat, if the spacing between the individual windings does not change. Consequently, it may be provided that a plurality of winding wires extending parallel to one another is fed to the shaping core and wound on the latter, wherein the spacing of the winding wires on the shaping core measured in the transport direction is reduced or increased during the course of the production process by changing the spacing of the winding wires fed in parallel to the shaping core.

In this variant, it may be provided, in particular, that transport jaw members are used, wherein at least some of the transport jaw members have groove spacings that differ from other transport jaw members. In this way, the wave winding produced may be properly grasped by the transport jaw members and further conveyed, even if these have winding spaces that change. Varying groove spacings may mean, in particular, that a first transport jaw member includes grooves having an initial but constant spacing and, in comparison, each next transport jaw member includes grooves having smaller or larger spacings.

### BRIEF DESCRIPTION OF THE DRAWINGS

The invention is explained in greater detail below with reference to FIGS. 1-6.

FIG. 1 shows a perspective schematic view of a wave winding device according to the invention,

FIG. 2 shows a sectional view along the transport direction X through a part of the wave winding device according to the invention in a first method step,

FIG. 3 shows a sectional view from FIG. 2 in a second method step,

FIG. 4 shows a sectional view from FIG. 2 in a third method step,

FIG. 5 shows a sectional view from FIG. 2 in a fourth method step, and

FIG. 6 schematically shows a process sequence, which illustrates the placement of the transport jaw members on the shaping core and the separation of the transport jaw members from the wave winding produced.

### DETAILED DESCRIPTION OF PREFERRED EMBODIMENTS

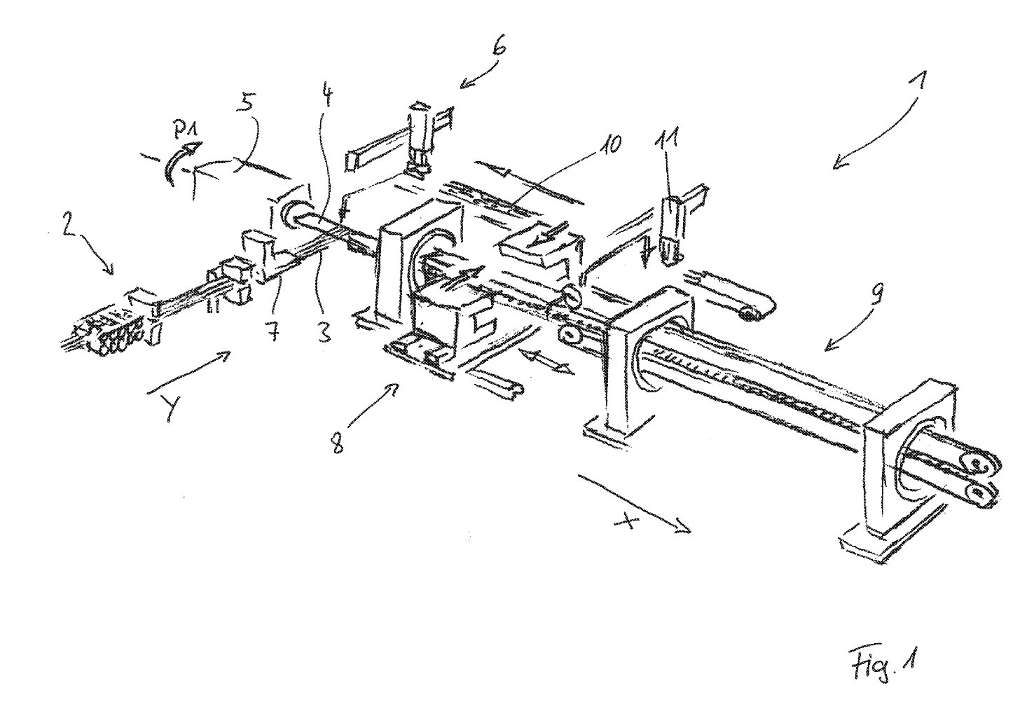

In the schematic arrangement of the winding device 1 according to the invention depicted in FIG. 1, one, respectively, a plurality of wires 3 is fed via a feed device 2 in a feed direction Y via one, respectively, a plurality of winding nozzles 7 to a shaping core 4. The shaping core 4 is part of a winding device, for which a drive 5 for the shaping core 4 also serves. The shaping core 4 can be rotated with the drive 5 about an axis P1. The winding axis P1 extends preferably perpendicularly to the feed direction Y and parallel to the transport direction X. Transport direction device the direction X, because the winding created on the shaping core 4 is further transported in that direction. A wire entrainment device 8, which is designed to further transport the resulting waving winding in transport direction X, serves to transport the wave winding created on the shaping core 4. Provided adjacent to the wire entrainment device 8 is a conveyor device 9, which takes the winding wire created, or winding wire still being created and, if necessary, feeds it to the further destination.

A transport jaw placing device 6, with the aid of which transport jaw members (not shown in FIG. 1) are placed on the shaping core 4, is provided in the area of the shaping core 4, the main direction of longitudinal extension of which extends in the transport direction. These transport jaw members are subsequently grasped and entrained via the wire entrainment device 8 and for their part serve to grasp and entrain the wave winding. Accordingly, a transport jaw receiving device 11 is provided at the end of the wire entrainment device 8, at which point the transport jaw members placed by the transport jaw placing device 6 on the shaping core or on the wave winding are lifted again from the wave winding. The transport jaw members received by the transport jaw receiving device 11 may be immediately guided back to the transport jaw placing device 6 via an optional transport jaw return device 10.

The terms “transport jaws” and “transport jaw members” are used synonymously below.

Further details of the process between the transport jaw placing device 6 and the transport jaw receiving device 11 are now explained in greater detail with reference to FIGS. 2-6.

The transport jaw members and transport jaws are identified in the following figures by the reference numeral 100. FIG. 2 depicts how a transport jaw member 100 (left side of the figure) is placed on the shaping core 4. A plurality of windings spaced apart from one another, which together is identified by the reference numeral 12, is located on the shaping core 4. Thus, 12 identifies, as a whole, the wave winding or a winding mat formed from a plurality of wave windings. The winding wires resting on the shaping core 4 or the individual wires situated next to one another surround the shaping core 4. A transport jaw member 100 is then placed on the upper side of the generally flat shaping core 4 and simultaneously linked to the transport jaw members 100 preceding in the transport direction X. Engagement sections 105 on the front side of the transport jaw member 100, in particular, which are able to engage corresponding engaging receptacles of a preceding transport jaw member 100, are used for linking. Thus, the transport jaw member 100, as it is set on the shaping core 4, is linked to the preceding transport jaw member 100. The transport jaw member 4 further includes a number of wire receiving grooves on the side facing the shaping core 4. Each wire receiving groove is intended for one wire section on the shaping core 4, so that when setting the transport jaw member 100 on the shaping core 4, a part of the winding 12 is positioned in each of the wire receiving grooves, so that the individual windings are held spaced apart from one another in the transport direction X with the aid of the transport jaw member during the further transport process.

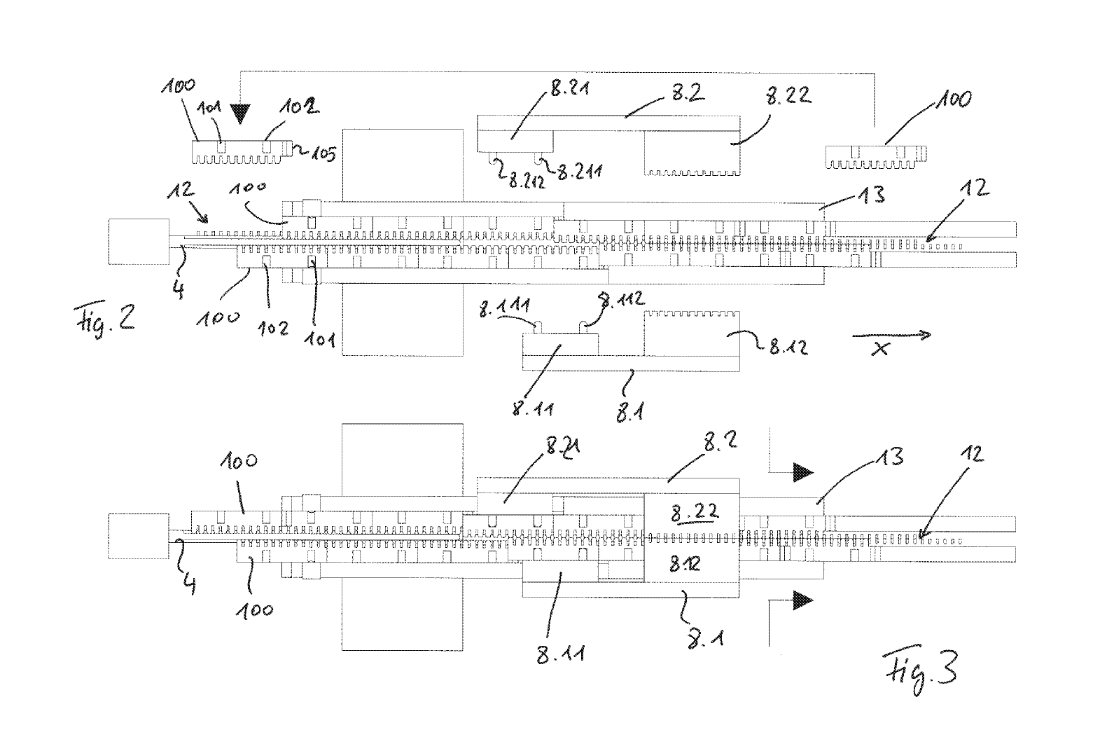

In FIG. 3, the transport jaw member is placed on the shaping core. The winding wire is then shifted on the shaping core in the transport direction, in order to bend the winding wire in the area of the winding heads of the wave winding to be formed. This shifting preferably always takes place via a forward feed of the transport jaw member, respectively, of the chain of transport jaw members 100 by half a length of a transport jaw member 100 in transport direction X. A transport jaw entrainment device 8.11, respectively, 8.21 is provided in the area of the wire entrainment device 8 for moving the chain of transport jaw members 100. The transport jaw entrainment device 8.11, respectively, 8.21 in the example, shown includes coupling members 8.211, 8.212, respectively, 8.111 or 8.112, designed as projections, which engage in corresponding engagement recesses, which may be holes, for example, if the projections are designed, for example, as pins. A plurality of coupling counter-sections designed as engagement recesses 101, 102 is advantageously situated on each transport jaw member 100 on the side opposite the wire receiving grooves, so that the respective transport jaw member does not tilt during entrainment by the transport jaw entrainment device 8.11, respectively, 8.21. The transport jaws are preferably also guided via a transport jaw guide 13 in the area of the wire entrainment device 8.

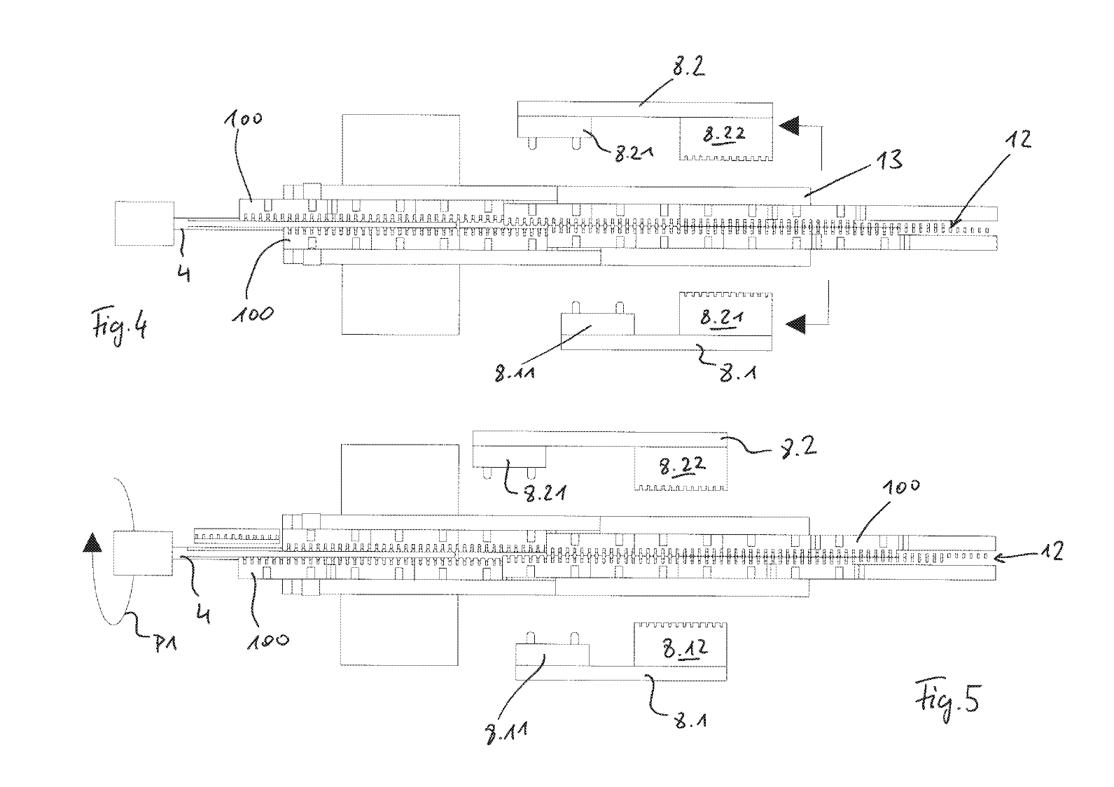

The transport jaw entrainment device 8.11, respectively, 8.21 is preferably mounted on a carriage 8.1, respectively, 8.2 so as to move along the transport direction X and may be advanced in or to the transport jaw members 100 resting on the wave winding in a direction perpendicular to the transport direction X relative to wave winding 12. For continuous transport, the transport jaw entrainment device is initially advanced to the transport jaws, wherein the coupling elements 8.211, 8.212, respectively, 8.111, 8.112 engage with the corresponding coupling counter-sections 101, respectively, 102 on the transport jaw members 100. Due to the linking of the transport jaw members 100, it is sufficient if merely one transport jaw member 100 is entrained in this manner. The advancement to, i.e. establishment of, the engagement between a transport jaw member 100 and the transport jaw entrainment device 8.11, respectively, 8.21, is followed by a movement of the same in the transport direction X, preferably with a forward feed by half the length of a transport jaw member 100, as a result of which the entire chain of transport jaw members 100 is transported further. It is in this manner, that the shifting described above occurs on the shaping core 4 and a configuration is obtained, as it is depicted in FIG. 4.

The engagement between the transport jaw entrainment device 8.11, respectively, 8.21 and the corresponding transport jaw member 100 is then released again and the transport jaw entrainment device is correspondingly guided back against the transport direction X into the starting position, where it may be advanced to the next transport jaw member 100, so that the sequence just described may be repeated.

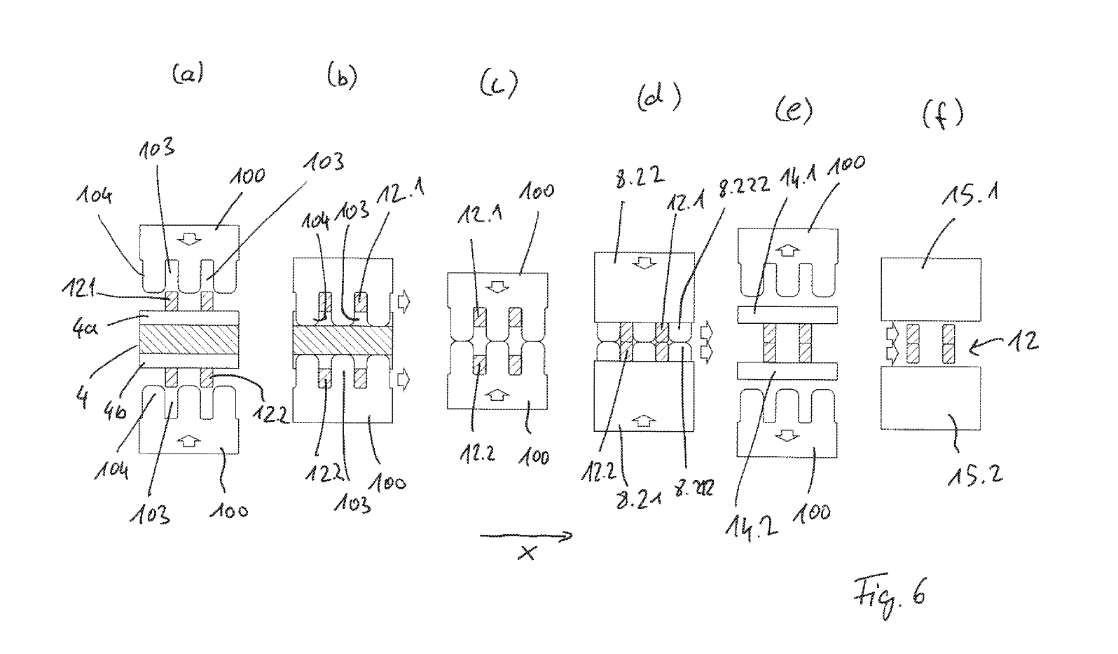

Before this repetition occurs, the shaping core 4 is initially rotated by 180°, as indicated by the arrow in FIG. 5, so that the transport jaw member 100 advanced by half a length is now situated in the drawing on the underside of the shaping core 4. On the upper side of the shaping core 4, new wires lie exposed, onto which another transport jaw member 100 may then be placed, as this is indicated in FIGS. 3 and 4. A pressing device 8.21, respectively, 8.22 may be situated on the same carriage 8.1, respectively, 8.2 in the transport direction X downstream from transport jaw entrainment device 8.11, respectively, 8.21. The arrangement may equally be provided separately—i.e. not on the same carriage. The pressing device 8.21, respectively, 8.22 serves to press the created windings, respectively, winding heads together once the windings have been removed from the shaping core 4 by the transport process described above.

The process sequence from FIG. 6 is more narrowly described in detail once again as a detail enlargement. The sections (a) through (f) characterize various sections during the course of the process, starting from the placement of the transport jaw members 100 on the shaping core 4 (a, b), followed by the withdrawal of the winding from the shaping core (c), the pressing of the winding (d), followed by the removal of the transport jaw members from the finished winding (e), and ending with the further transport of the finished winding (f).

Initially, the transport jaw members 100 are placed on the shaping core 4 (a, b). For this purpose, the shaping core 4 preferably includes recesses or grooves 4a, 4b on the upper side and the lower side, which extend in the longitudinal direction or transport direction X of the shaping core 4, which are dimensioned so that a part of the projections 104 situated between the wire receiving grooves 103 of the transport jaw members 100 is able to dip into the corresponding recesses 4a, respectively, 4b, wherein the individual windings 12.1, respectively 12.2 are received in the corresponding wire receiving grooves 103 of the transport jaw members 100. This situation is depicted, in particular, in section (b). The advantage of these recesses 4a, respectively, 4b is that the corresponding windings 12.1, respectively, 12.2 are pressed down to the bottom of the wire receiving grooves 103, so that they are unable to again slip out of the transport jaw members 100 during the further transport and after the winding 12 has been stripped (c) from the shaping core 4.

After the transport jaw members have been stripped (d) from the shaping core 4, the corresponding windings are pressed against one another by pressing tools 8.21, respectively, 8.22. With the aid of spacer elements 8.212, respectively, 8.222 on the pressing tools 8.21, respectively, 8.22, it is ensured here that the winding mat 12 with its windings 12.1, respectively, 12.2 is not crushed or damaged during pressing. After the pressing process, the transport jaw members 100 are removed from the wave winding 12 and fed for further use (e). In the process, it is useful to separate the transport jaw members 100 and the wave winding from one another by means of a stripper 14.1, 14.2, since otherwise the windings will potentially tilt in the wire receiving grooves of the transport jaw members 100. Finally, the finished wave winding 12 is transported further (f) in transport direction X in the form of a winding mat, wherein it may be transported via guide elements 15.1, respectively, 15.2, which may be designed, in particular, as toothed belts, so that the teeth are able to grip between the individual windings.

In the drawings, it is not shown that for this purpose, multiple transport jaw members may be simultaneously placed parallel to one another on the shaping core 4 and on the windings situated thereon in the width direction of the wave winding 12. If, in this regard, the transport jaw members 100 are spaced apart from one another in the width direction of the resulting wave winding, a conveyor device having a toothed belt, for example, adjacent to the wire entrainment device 8 may reach between two transport jaws 100 situated in parallel. In this way, it is ensured that the winding mat 12 may already be grasped and taken by the following conveyor device even when the transport jaw members (e) are released. This may prevent the winding mat 12 from slipping or losing its position in this area.

As described further above, it is possible with the loose transport jaw members to produce winding mats 12, which include winding spacings that are changeable in the running direction X, in order, for example, to facilitate the introduction of a finished winding mat into a laminated core. For this purpose, the device according to the invention may include a set of transport jaw members 100, each of which has different groove spacings.

1. A wave winding device (1), comprising:
a feed device (2), which provides at least one winding wire (3) via at least one winding nozzle (7) and transports it in a feed direction (Y);
a winding device (5, 4), which winds the fed winding wire (3) and comprises a shaping core, which is driven so as to rotate about a rotation axis (P1), and which extends in a transport direction (X), a wire entrainment device (8) for grasping a winding or a plurality of windings situated on the shaping core (4) and for entraining it or them in the transport direction,
wherein the wire entrainment device (8) comprises:
a plurality of loose transport jaw members (100), each of which has a plurality of wire receiving grooves (103);
a transport jaw placing device (6), which is situated in the area of the shaping core (4) and is for placing the transport jaw members (100) on the winding wire (3) situated on the shaping core (4);
a transport jaw receiving device (11) for receiving transport jaw members (100); and
a transport jaw entrainment device (8.11, 8.21) for engaging with the transport jaw members (100) and for moving these in transport direction (X).

2. The wave winding device (1) according to claim 1,
further comprising
a transport jaw return device (10) for returning the transport jaw members (100) received by the transport jaw receiving device (11) to the transport jaw placing device (6).

3. The wave winding device (1) according to claim 1,
wherein
the transport jaw members (100) include linking sections for linking adjacent transport jaw members (100) to one another.

4. The wave winding device (1) according to claim 1,
wherein
the wire entrainment device (8) includes a transport jaw guide, in which the transport jaw members (100) may be guided in transport direction (X).

5. The wave winding device (1) according to claim 1,
wherein
of the plurality of transport jaw members (100), at least some transport jaw members (100) comprise groove spacings differing from other transport jaw members (100).

6. The wave winding device (1) according to claim 1,
wherein
the wire entrainment device (8) is rotatable in synchrony with the shaping core (4) about an axis parallel to the transport direction (X).

7. The wave winding device (1) according to claim 1,
further comprising
a pressing device (8.12, 8.22) advanceable in the direction of the wave winding (12) and movable in transport direction (X), the pressing device (8.12, 8.22 being situated downstream from the transport jaw entrainment device (8.11, 8.21) in transport direction (X).

8. The wave winding device (1) according to claim 1,
wherein
the transport jaw entrainment device (8.11, 8.21) is movable in transport direction (X) and advanceable perpendicular to the transport direction in the direction of the wave winding.

9. The wave winding device (1) according to claim 1,
further comprising
a stripping device (14.1, 14.2), which facilitates the release of the transport jaw members (100) from the wave winding (12).

10. The wave winding device (1) according to claim 1,
further comprising
a conveyor device (9) situated in transport direction (X) downstream from the wire entrainment device (8), wherein the conveyor device (9) takes the wave winding (12) from the wire entrainment device (8) and transports the wave winding (12) further.

11. The wave winding device (1) according to claim 10,
wherein
the conveyor device (9) comprises a toothed belt, the teeth of which entrain the wave winding (12).

12. A method for producing a wave winding by using a wave winding device (1), the method comprising:
i) feeding a winding wire (3) to a winding device (4, 5) that includes a shaping core (4);
ii) winding the wire (3) with the aid of the winding device (4, 5) by rotating the shaping core;
iii) transporting the wire (3) situated on the shaping core (4) in a transport direction (X) parallel to the rotation axis (P1) of the shaping core (4);
iv) placing at least one loose transport jaw member (100), which has a plurality of wire receiving grooves (103), on the shaping core (4) wound with the wire (3), so that at least one winding of the wire (3) is received in a wire receiving groove (103), and
v) moving the transport jaw member (100) in transport direction (X).

13. The method according to claim 12,
wherein
steps iv) and v) are carried out repeatedly.

14. The method according to claim 12,
further comprising rotating the shaping core (4) by 180° between steps iv) and v).

15. The method according to claim 14,
wherein
movement step v) is carried out in such a way that the placed transport jaw member (100) is moved by approximately half the length of the placed transport jaw member (100) in transport direction (X) before the shaping core (4) is rotated by 180°.

16. The method according to claim 12,
further comprising
when placing a new transport jaw member, then new transport jaw member is linked with the transport jaw member (100), in each case, immediately preceding in transport direction (X).

17. The method according to claim 12,
wherein
in step iv), two transport jaw members (100) are placed on the shaping core spaced parallel apart from one another.

18. The method according to claim 12,
wherein
to carry out step iv), a transport jaw entrainment device (8.11, 8.21) moveable in transport direction (X) is advanced to a transport jaw member (100), engaged with the transport jaw member (100), subsequently fed forward and after being fed forward, released again from engagement with the transport jaw member.

19. The method according to claim 12,
wherein
the wave winding (12) is pressed together by means of a pressing device (8.12, 8.22) movable in synchrony with the forward feed movement of the transport jaw members (100) in transport direction (X).

20. The method according to claim 12,
wherein
a plurality of winding wires extending in parallel are fed to and wound on the shaping core (4), wherein the spacing of the winding wires (3) measured in transport direction (X) is reduced or is increased during the course of the production process of the winding mat (12) by changing the spacing of the winding wires (3) fed in parallel to the shaping core (4).

21. The method according to claim 20,
further comprising
using transport jaw members (100), of which at least some transport jaw members (100) have groove spacings differing from other transport jaw members (100).
